(19) United States
(12) Patent Application Publication
(10) Pub. No.: US 2016/0061541 A1
(43) Pub. Date: Mar. 3, 2016

(54) CONTACTING DEVICE AND METHOD

(71) Applicants: Guang X. Chen, Williamsville, NY (US); Steven C. Brown, Amherst, NY (US); Andrew P. Dybdahl, Lockport, NY (US); Kirk F. Larson, Amherst, NY (US); John P. Ricotta, Kenmore, NY (US)

(72) Inventors: Guang X. Chen, Williamsville, NY (US); Steven C. Brown, Amherst, NY (US); Andrew P. Dybdahl, Lockport, NY (US); Kirk F. Larson, Amherst, NY (US); John P. Ricotta, Kenmore, NY (US)

(21) Appl. No.: 14/833,316

(22) Filed: Aug. 24, 2015

Related U.S. Application Data
(60) Provisional application No. 62/041,681, filed on Aug. 26, 2014.

(51) Int. Cl. F28F 25/08; B01D 3/00

(52) U.S. Cl. CPC F28F 25/08; B01D 3/008

(57) ABSTRACT

The present invention provides a vapor-liquid contact device for use in a distillation column and method incorporating the use of such a vapor-liquid contact device. The vapor-liquid contact device has arrays of elongated strips to support a falling film of a liquid and contact of a vapor with the film. The strips are supported in a structure having top and bottom sections connected to opposite ends of the strips. The top sections have apertures in registry with the strips so that liquid distributed to the top section seeps out of the apertures to initiate formation of the falling film. Openings are provided at the top and bottom sections, so that a vapor is able to pass through the support structure to contact the falling film to effect contact between the liquid and the vapor. Liquid distributors are associated with the top section to distribute the liquid to the apertures.

### CROSS REFERENCE TO RELATED APPLICATIONS

This application claims the benefit of and priority to United States provisional patent application Ser. No. 62/041,681 filed Aug. 26, 2014 the disclosure of which is incorporated by reference herein.

### FIELD OF THE INVENTION

The present invention relates to a vapor-liquid contact device that can be used in a distillation column and a distillation method relating to the use of such a device within a distillation column in which a falling film of a liquid is contacted with a vapor, which in case of distillation, are vapor and liquid phases of a mixture to be distilled. More particularly, the present invention relates to such a vapor-liquid contact device in which the falling film is formed on arrays of elongated strips supported within a structure through which the vapor is passed to contact the falling film and thereby to effect contact between the vapor and the liquid.

### BACKGROUND OF THE INVENTION

Vapor-liquid contact devices are used in distillation columns to contact and ascending vapor phase with a descending liquid phase of a mixture to be distilled. Mass transfer occurs between the vapor and liquid phases such that the concentration of the lighter or less volatile components of the mixture increases within the ascending vapor phase as it ascends and the concentration of the heavier or less volatile components increases within the liquid phase as it descends. Additionally, such devices are also used in direct contact heat exchangers and like equipment to transfer heat and also mass between liquids and vapors.

An example of a common distillation employing such vapor-liquid contact devices is cryogenic air separation in which air is compressed and then purified of higher boiling contaminants, such as water vapor and carbon dioxide that could freeze at the low temperatures at which such processes are conducted. The compressed and purified air is then cooled to at or near its dewpoint and then distilled in one or more distillation columns to produce products enriched in oxygen, nitrogen and argon and other components of the air. For instance, the compressed, purified and cooled air may be introduced into a distillation column to initiate formation of the ascending vapor phase which will be become ever more rich in nitrogen as it ascends. The resulting nitrogen-rich vapor column overhead can in part be condensed to form a reflux stream that is introduced into the top of the column to initiate the formation of a descending liquid phase that contacts the ascending vapor phase in one or more arrangements of vapor-liquid contact devices to become richer in oxygen as it descends. The resulting oxygen-rich liquid column bottoms can be further refined in other columns or used in the condensation of the nitrogen-rich vapor if such component is the only desired product of the separation.

Typical vapor-liquid contact devices are sieve trays, structured packing and random packing. Sieve trays consist of perforate plates stacked within the column. Higher plates feed the descending liquid to lower plates through the use of downcomers and vapor ascends through the plates by means of the plate perforations. The contact between the liquid and vapor produces vapor and liquid mixtures that will vary in composition from plate to plate and in a manner described above. Structured packing and random packing contact the descending liquid phase in the form of a film with the ascending vapor phase, ascending through the packing. Random packing consists of individual packing elements that are supported in mass within the distillation column. Structured packing consists of corrugated sheets arranged so that the corrugations cross. The contact points of the corrugations ensure that both the liquid film and the vapor spread out throughout the packing. Sieve trays and random packing, as opposed to structured packing have a large pressure drop associated with their use. In case of air separation, the degree to which the air has to be compressed is directly effected by such a pressure drop. While structured packing has a low pressure drop, the mixing of liquid and vapor is not perfect due to imperfections in the packing and installation defects resulting in packing that is not completely level while within the distillation column.

As will be discussed, among other advantages of the present invention is the provision of a vapor-liquid contact device suitable for such uses as distillation and direct contact heat exchange that has a low pressure drop and that is designed to distribute the liquid to avoid problems in which the mixing of liquid is not uniform within the device.

### SUMMARY OF THE INVENTION

The present invention provides a vapor-liquid contact device that comprises a plurality of arrays of elongated strips to support a falling film of a liquid, descending on the elongated strips on opposite surfaces of each of the elongated strips. A support structure is also provided that has a top section and a bottom section, spaced apart from one another. The top and bottom sections are connected to the arrays of the elongated strips, at opposite ends of the elongated strips and support the plurality of arrays of elongated strips in a parallel relationship and with the opposite surfaces of the elongated strips spaced apart from one another, as viewed between adjacent strips, so as to prevent liquid in the falling film from migrating from one of the adjacent strips to the other of the adjacent strips by means of surface tension of the liquid. The top section has apertures in registry with the elongated strips so that liquid distributed to the top section seeps out of the apertures onto the opposite surface of each of the strips to initiate the formation of the falling film of the liquid. Additionally, the support structure has openings, at the top and bottom sections, so that a vapor is able to pass through the support structure to contact the falling film to effect contact between the liquid and the vapor. Liquid distributors associated with the top support elements distribute the liquid to the apertures.

As can be appreciated, the use of individual strips associated with apertures that individually distribute the liquid to the strips provide for a more controlled distribution of the liquid than in prior art packing devices such as random and structured packing. Further, the structure with the arrays of the strips can be sufficiently open so that a device of the present invention has a low pressure drop.

The vapor-liquid contact device can be used in a variety of applications such as in direct heat transfer and in distillation. In this regard, the present invention provides a distillation column having an outer shell having inlets and outlets to allow a vapor and a liquid to be introduced into the cylindrical shell and thereby initiate formation of a liquid phase and a vapor phase of a mixture to be distilled and a vapor-liquid contact device located within the outer shell and having the features described above. Where such a vapor-liquid contact device is used in distillation, the plurality of arrays of elongated strips support a falling film of the liquid phase with the falling film descending on the elongated strips on opposite surfaces of each of the elongated strips. The structure has a top section and a bottom section, spaced apart from one another, connected to the arrays of the elongated strips, at opposite ends of the elongated strips, to at least in part form a support structure. The support structure supports the plurality of arrays of elongated strips in a parallel relationship and with the opposite surfaces of the elongated strips spaced apart from one another, as viewed between adjacent strips, so as to prevent liquid in the falling film from migrating from one of the adjacent strips to the other of the adjacent strips by means of surface tension of the liquid. The top section has apertures in registry with the elongated strips so that liquid distributed to the top section seeps out of the apertures onto the opposite surfaces of each of the strips to initiate the formation of the falling film of the liquid. The support structure has openings, at the top and bottom support elements, so that the ascending vapor phase is able to pass through the structure and to contact the falling film to effect mass transfer between the liquid phase and the ascending vapor phase and thereby increase concentrations of heavier components of the mixture within the liquid phase at it descends and lighter components of the mixture within the ascending vapor phase as it ascends. Liquid distributors associated with the top section to distribute the liquid to the apertures and a plurality of wiper bands connected to the support structure to prevent the liquid from by-passing the vapor-liquid contact device by flowing along an inner surface of the outer shell of the distillation column.

In a vapor-liquid contact device of the present invention and used in any application, including, but not limited to distillation, the outer shell can be of cylindrical configuration. The top section and the bottom section comprise pairs of top and bottom support elements, each of annular configuration and of successively decreasing radius such that as between adjacent pairs of top and bottom support elements an inner pair is located within an outer pair of the pairs of top and bottom support elements. The support structure can have an axial elongated member passing through geometric centers of the pairs of top and bottom support elements. The pairs of top and bottom support elements are connected to the axial elongated member to support the pairs of top and bottom support elements and the arrays of the elongated strips are connected to the pairs of top and bottom support elements such that the elongated strips of each of the arrays have a radial orientation in a transverse direction of the elongated strips.

Preferably, each of the pairs of top and bottom support elements can be connected to a single array of the plurality of arrays of elongated strips. The top support elements of the pairs of the top and bottom support elements can be vertically staggered so that as between the adjacent pairs of the top and bottom support elements, a top support element of an inner pair of the top and bottom support elements is located above the top support element of the outer pair of the pairs of top and bottom support elements and one of the openings in the support structure at the top support elements for passage of the vapor is formed by a spacing resulting from the vertical stagger between the top support elements of the adjacent pairs of the top and bottom support elements. Additionally, the liquid distributors can comprise reservoirs to retain the liquid phase. The reservoirs can have inner and outer cylindrical sidewalls connected to annular bottom walls and the annular bottom walls are connected to the top support elements and have corresponding apertures in registry with the apertures of the top support elements to allow the liquid to flow from the reservoirs to the apertures of the top support elements. A pre-distributor can be located above the liquid distributors. The pre-distributor has a bottom wall of cruciform configuration and interconnected rectangular side and end walls connected to the bottom wall to retain the liquid. The bottom wall has further openings overlying the liquid distributors to distribute the liquid to the reservoirs of the liquid distributors.

Preferably, an innermost of the liquid distributors can be connected to the axial elongated member and successive outer liquid distributors are connected to inner distributors by tabs and an innermost bottom support element of the pairs of top and bottom support elements is connected to the axial elongated member and successive bottom support elements of the pairs of top and bottom support elements are connected to one another. The connection of the pairs of top and bottom support elements to the axial elongated member is carried out as a result the connections of the liquid distributor by the tabs and the bottom support elements to one another. Also, the axial elongated member has a keyway to align the top and bottom support members and thereby prevent the elongated strips from twisting. In a particularly preferred embodiment, the elongated strips are flexible and have a pair of tabs located at opposite ends of each of the elongated strips and the top and bottom support elements have slots within which the opposite ends of the elongated strips extend with the pair of tabs folded in opposite directions to hold the elongated strips in place and in tension. Also, a fixed tension plate can be connected to the axial elongated member and the bottom support elements are connected to the fixed tension plate by threaded connectors that allow the tension of the elongated strips to be adjusted.

The present invention also provides a distillation method for distilling a mixture. In such method, a vapor and a liquid are introduced into an outer shell of a distillation column, thereby initiating formation of a liquid phase and an ascending vapor phase of the mixture to be distilled. A falling film of the liquid phase, descending on opposite surfaces of elongated strips of a plurality arrays of the elongated strips, is contacted with the ascending vapor phase to effect mass transfer between the descending liquid phase the ascending vapor phase to thereby distill the mixture by increasing concentrations of lighter components of the mixture in the ascending vapor phase as it ascends and the heavier components of the mixture in the descending falling film as it descends. The plurality of arrays of elongated strips are supported within a support structure in a parallel relationship and with the opposite surfaces of the elongated strips spaced apart from one another, as viewed between adjacent strips, to prevent liquid in the falling film from migrating from one of the adjacent strips to the other of the adjacent strips by means of liquid surface tension. The support structure has a top section and a bottom section connected to the arrays of the elongated strips, at opposite ends of the elongated strips. The falling film is formed by distributing the liquid phase from liquid distributors associated with the top section to apertures defined in the top section and in registry with the elongated strips so that liquid phase seeps out of the apertures onto the opposite surface of each of the strips to initiate the formation of the falling film of the liquid phase. The ascending vapor phase is introduced into the structure at the bottom section so that it ascends within the structure to contact the falling film and escapes from the arrays of the elongated strips after having contacted the falling film from openings in the structure at the top section. The liquid phase is prevented from by-passing the support structure and the elongated strips by flowing along an innerwall of the outer shell of the distillation column with a plurality of wiper bands connected to the support structure.

The top section and the bottom section can comprise pairs of top and bottom support elements, each of annular configuration and of successively decreasing radius such that as between adjacent pairs of top and bottom support elements an inner pair is located within an outer pair of the pairs of top and bottom support elements and the support structure has an axial elongated member passing through geometric centers of the top and bottom support elements. The pairs of top and bottom support elements are connected to the axial elongated member to support the pairs of top and bottom support elements and the arrays of the elongated strips are connected to the pairs of top and bottom support elements such that the elongated strips of each of the arrays have a radial orientation in a transverse direction of the elongated strips. The top support elements of the pairs of the top and bottom support elements are vertically staggered so that as between the adjacent pairs of the top and bottom support elements, a top support element of an inner pair of the top and bottom support elements is located above the top support element of the outer pair of the pairs of top and bottom support elements and one of the openings in the support structure at the top support elements for passage of the vapor is formed by a spacing resulting from the vertical stagger between the top support elements of the adjacent pairs of the top and bottom support elements. Preferably, the liquid distributors comprise reservoirs to retain the liquid phase. The reservoirs have inner and outer cylindrical sidewalls connected to a annular bottom wall that is in turn connected to the top support elements and the liquid phase is distributed from the liquid distributors from corresponding apertures defined in the annular bottom wall and in registry with the apertures of the top support elements to allow the liquid to flow from the reservoirs to the apertures of the top support elements. In this regard, the liquid phase can be pre-distributed from a pre-distributor located above the liquid distributors to the reservoirs of the liquid distributors from further openings defined in the bottom wall and overlying the liquid distributors.

In any aspect of the present invention, the mixture to be distilled can be air or one enriched in components of the air. For example, the mixture can be a crude argon mixture extracted from a lower pressure column of a distillation column system for further a refinement in an argon column.

### BRIEF DESCRIPTION OF THE DRAWINGS

While the present invention concludes with claims distinctly pointing out the subject matter that applicants regard as their invention, it is believed that the invention will be better understood when taken in connection with the accompanying drawings in which:

FIG. 1 is a sectional view of a vapor-liquid contact device employed in a distillation column for carrying out a method in accordance with the present invention;

FIG. 2 is a perspective view of the vapor-liquid contact device shown in FIG. 1 with portions removed to illustrate the attachment of a wiper band to an axial elongated member forming part of the support structure included in the device;

FIG. 3 is a fragmentary, perspective view of the vapor-liquid contact device shown in FIG. 1 with a portions of liquid distributors removed to show the connection of elongated strips to top support elements of the support structure;

FIG. 4 is a fragmentary, perspective view of a connection of an elongated strip to a top support member;

FIG. 5 is a fragmentary, bottom perspective view of the vapor-liquid contact device shown in FIG. 1 with portions of bottom support members forming part of the support structure removed to show connection of the elongated strips to the bottom support members and with portions of a fixed tension plate used in maintaining the elongated strips in tension removed;

FIG. 6 is a top plan view of the vapor-liquid contact device shown in FIGS. 1; and

FIG. 7 is a perspective view of an alternative embodiment of the vapor-liquid contact device of the present invention.

### DETAILED DESCRIPTION

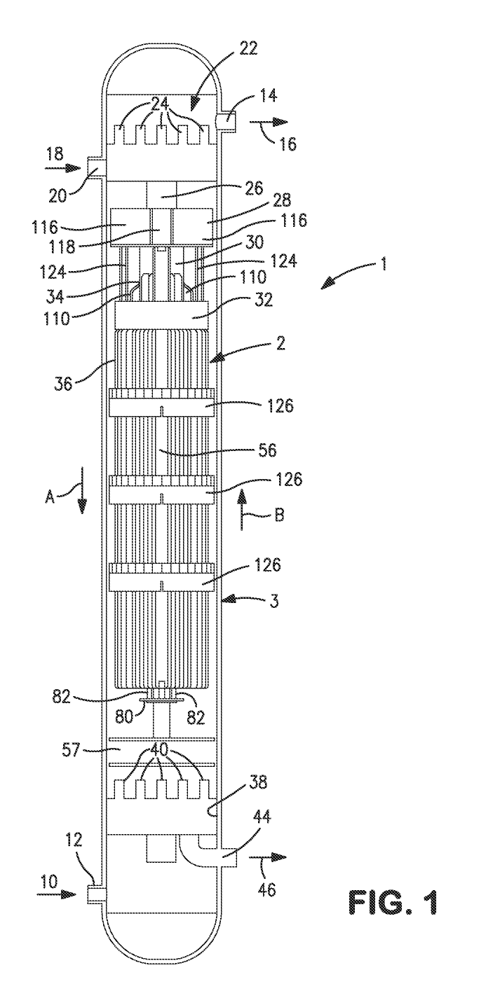

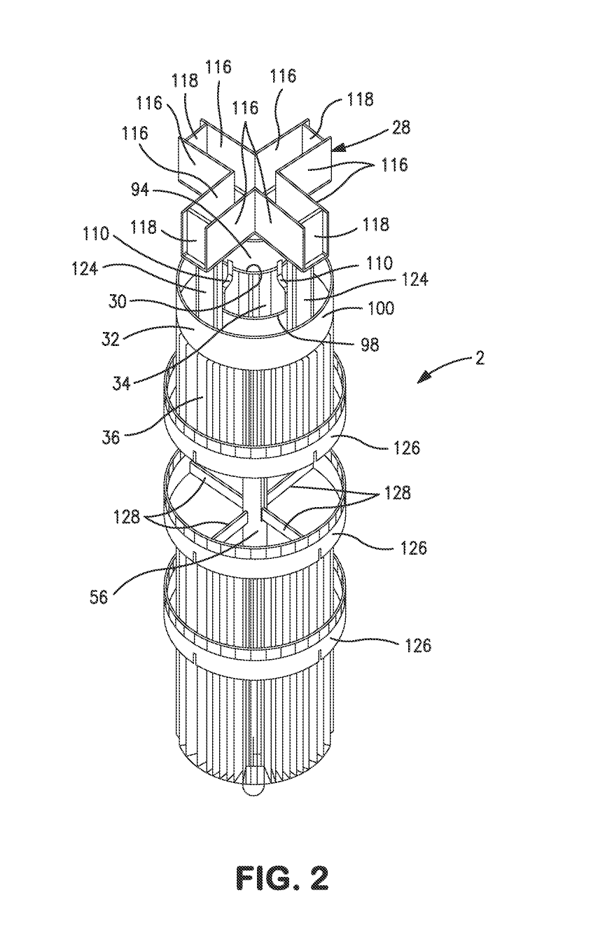

With reference to FIGS. 1 and 2, a distillation column 1 is illustrated that contains a vapor-liquid contact device 2 in accordance with the present invention. Vapor-liquid contact device 2 functions to contact an ascending vapor phase, ascending within distillation column 1, with a descending liquid phase, descending within distillation column 1 and thereby separate components of a mixture to be distilled.

For example, the mixture could be air and distillation column 1 would function to separate nitrogen from oxygen. In this regard, purified, cooled and compressed air would be introduced as a feed stream 10 through a bottom inlet 12 located in the bottom of the distillation column 1 to initiate the formation of the ascending vapor phase which would become ever more rich in nitrogen as it ascended distillation column 1 through mass transfer with the descending liquid phase produced as a result of contact brought about by the vapor-liquid contact device 2. The resulting nitrogen-rich vapor column overhead would be discharged from a top outlet 14 of the distillation column 1 as a nitrogen-rich vapor stream 16. In a manner known in the art, nitrogen-rich vapor stream 16 could be partially taken as a product and used in cooling the incoming air to a temperature suitable for its distillation and in part condensed in a heat exchanger to produce a reflux stream 18 introduced into a top inlet 20 located at the top of the distillation column 1. Such introduction of liquid reflux would initiate formation of the descending liquid phase. Specifically, liquid is introduced into collector tray 22 having chimneys 24 for the passage of the vapor to be discharged from top outlet 14 and a pipe 26 that feeds the liquid to a pre-distributor 28. The liquid from the pre-distributor 28 is in turn fed to distributors 30 and 32 of the vapor-liquid contact device 2. The descending liquid phase, descends as film formed on inner and outer arrays of elongated strips 34 and 36 of the vapor-liquid contact device 2 to contact the ascending vapor phase, ascending through the structure thereof. The liquid, after having contacted the vapor is collected in a collection tray 38 having chimneys 40 and a pipe 42 connected to a bottom liquid outlet 46 to discharge the oxygen-rich liquid stream 48. This liquid is introduced into the heat exchange to condense the nitrogen-rich vapor after having been expanded.

As will be appreciated by those skilled in the art, although vapor-liquid contact device 2 can be used in distillation, as described above, it can also be used in other applications, for instance, direct contact heat exchange where vapor and liquids are contacted with or without appreciable mass transfer between the vapor and the liquid.

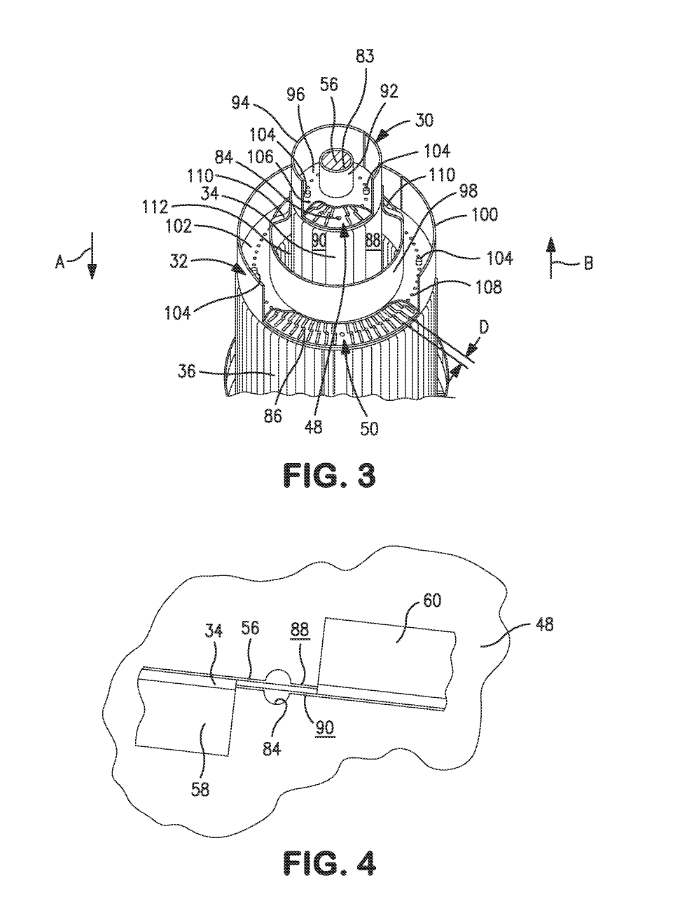

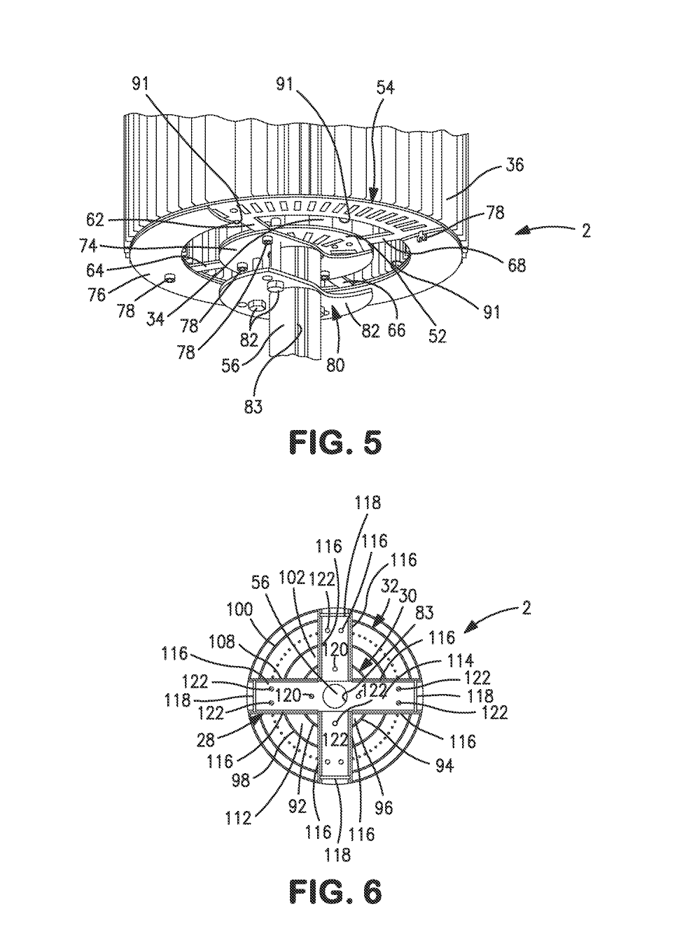

With additional reference to FIGS. 3, 4 and 5, the elongated strips 34 and 36 are supported by a support structure having a top section and a bottom section. The top section is formed by top support elements 48 and 50, best seen in FIG. 3 and the bottom section is formed by bottom support elements 52 and 54, best seen in FIG. 5. The top and bottom support elements 48, 50 and 52, 54, respectively, are spaced apart from one another and connected to the elongated strips 34, 26, at opposite ends thereof. As illustrated, the top and bottom support elements 48, 50 and 52, 54 are of annular configuration support elements and of successively decreasing radius as between adjacent pairs for example, top support element 48 has a smaller radius than top support element 50 and bottom support element 52 has a smaller radius than bottom support element 54. This allows the top and bottom support elements 48 and 52 to be positioned inside the top and bottom support element 50 and 54 and the elongated strips 34 to be supported as an array of strips within the elongated strips 36 that forms an outer array of such strips.

Preferably the elongated strips 34 and 36 are flexible and maintained in tension by the supporting structure. In this regard, the spacing of the top and bottom support elements 48, 50 and 52, 54 is maintained by a central axial elongated member 56 that also forms part of the support structure. With particular reference to FIG. 4, as an example of a preferred connection, the top and bottom support elements 48 and 52 can each be provided with slots 56 and the elongated strips 34 can be provided with tabs 58 and 60 that are folded in opposite directions to lie flush against the surfaces of the top and bottom support elements 48 and 52 to hold the elongated strips 34 in position. The same arrangement would be used to connect the elongated strips 36 to the top and bottom support elements 50 and 54. As shown in FIG. 5, the bottom support elements 50 and 54 are connected to one another by radially oriented connection elements 62, 64, 68 and 70. Annular cover plates 74 and 76 are connected to bottom support elements 52 and 54, respectively, by machine screws 78. The annular cover plates 74 and 76 cover the tabs 58 and 60 of the elongated strips 34 and 36 and act as keepers to help hold the elongated strips 34 and 36 in position attached to the bottom support elements 52 and 54. The tension of the elongated strips 34 can be adjusted by means of a fixed tension plate 80 attached to the axial elongated member 56 and threaded connectors 82 passing through the fixed tension plate 80, the annular cover plate 74 and the bottom support element 52. When the threaded connectors 82 are tightened, tension on the elongated strips 34 and 36 will increase.

As illustrated, each of the arrays of elongated strips 34 and 36 are supported in a parallel relationship and with the opposite surfaces of the elongated strips spaced apart from one another, as viewed between adjacent strips, so as to prevent liquid in the falling film from migrating from one of the adjacent strips to the other of the adjacent strips by means of surface tension of the liquid. For example, with particular reference to FIG. 3, the elongated strips 36 are spaced apart from one another a distance “D” for such purposes. The actual distance should be a minimum distance for such purposes to obtain the greatest surface area obtainable for contact between the vapor and liquid phases of the mixture to be distilled. The proper alignment of the elongated strips 34 and 36 as well as other components can be assured by the use of a keyway engagement by means of a keyway slot 83 in elongated axial member 56. Keys wedged into corresponding slots within the components, for instance, top and bottom support members 48 and 50 help maintain proper alignment of the components.

The top support elements 48 and 50 have apertures 84 and 86, respectively. Liquid is fed to the apertures 84 and 86 from the liquid distributors 30 and 32. The liquid seeps out of the apertures 84 and 86 and onto opposite surfaces of each of the elongated strips 34 and 36, for instance, surfaces 88 and 90 for an elongated strip 34 shown in FIGS. 3 and 4. The resulting liquid as a film proceeds in a downward direction “A” by force of gravity. The descending liquid, after having contacted the vapor, pass out of open areas 91 (shown in FIG. 5) that are situated between bottom support elements 52 and 54 and the respective annular cover plates 74 and 76. Although both the top support elements 48 and 50 and their respective liquid distributors 30 and 32 could be formed of one piece, preferably, they are formed separately. As illustrated, liquid distributor 30 has inner and outer cylindrical sidewalls 92 and 94 connected to an annular bottom wall 96 to form a liquid reservoir. The inner cylindrical sidewall 92 surrounds the axial elongated element 56. Similarly, the liquid distributor 32 has inner and outer cylindrical sidewalls 98 and 100 connected to an annular bottom wall 102. The advantage of such an arrangement is that the tabs 58 and 60 of the elongated strips 34 and 36 can be held in place by the annular bottom walls 96 and 102 after attachment with the use of machine screws 104. In order to distribute the liquid to the apertures 84 and 86 respective corresponding apertures 106 and 108 are defined in the annular bottom walls 96 and 102. They are “corresponding” because they are in alignment with their respective underlying apertures 84 and 86. Preferably, the liquid distributors 30 and 32 are connected to one another by tabs 110 to help in the assembly of the same. It is to be noted that the liquid distributors such as 30 and 32 should allow a sufficient depth of liquid to accumulate to ensure uniform and equal distribution of the liquid to the apertures and their associated elongated strips such as 34 and 36.

It is appropriate to point out that although the use of flexible thin strips to form the elongated strips 34 and 36 is preferred it is possible to attach the same to the top support elements 48 and 50 by means of adhesives and the like. Consequently, it is possible to form the liquid distributors 30 and 32 and the respective underlying top support elements 48 and 50 in single units. In such case, the annular bottom walls of such distributors would form the top support elements and there would be no corresponding apertures 106 and 108. Similarly, in such an embodiment, the annular cover plates 74 and 76 could be dispensed with because there would not be connections using slots and tabs. It is to be noted that elongated strips 34 and 36 or any like elements used in an embodiment of the present invention could have a surface texture or even a coating could be applied to each of the strips. Additionally, although not specifically illustrated, the elongated strips used in an embodiment of the present invention could be fabricated from a woven gauze or even a plastic. At another extreme, the strips could be somewhat rigid.

The ascending vapor phase is introduced into the vapor-liquid contact device 2 through the openings 91 located at the bottom thereof and ascends in the direction “B” shown in FIGS. 1 and 3. With additional reference to FIG. 6, the vapor contacts the liquid film descending on the elongated strips 34 and 36 and the vapor phase escapes from the vapor-liquid contact device 2 through an opening 112 in the support structure formed by vertically staggering top support elements 48 and 50 so that the inner top support element 48 is located above the outer top support element 50. Thus, the opening 112 in the support structure is formed by a spacing between the top support element 48 and the top support element 50. While embodiments of the present invention are possible with the top support elements situated at the same level, such embodiments would not be preferred due to the resulting complexity of construction and the higher pressure drip produced by a more narrow area for the vapor phase to escape. Further, although the opening 112 is formed by an open region of the structure, it is understood that a shell like covering could be provided within such spacing having individual openings for the escape of the vapor phase. However, due to the higher pressure drop, such an embodiment would not be preferred.

The use of pre-distributor 28 is preferred to avoid concentration gradients in the liquid fed to vapor-liquid contact device 2. Pre-distributor 28 is preferably provided with a bottom wall 114 of cruciform configuration and a set of interconnected rectangular side and end walls 116 and 118, respectively connected to the bottom wall 114. This configuration is preferred in that it provides a large open area and thus, a low pressure drop for the rising vapor phase. An array of four central openings 120 is provided in the bottom wall 114 to feed liquid to the liquid distributor 30 and outer openings 122 are provided to feed liquid to the liquid distributor 32. In order to prevent any liquid from contacting the column shell 3 of the distillation column, down legs or conduits 124 are provided to conduct the liquid from the pre-distributor 28 to the liquid distributor 32. In this regard and with specific reference to FIG. 2, in order to prevent downcoming liquid from bypassing the vapor-liquid contact device 2, wiper bands 126 can be provided to contact the column shell 3 and conduct liquid back to the elongated strips 36. Each of the wiper bands 126 is connected to the elongated central member 56 by four connection legs 128. It is to be noted that other forms of a pre-distributor could be used. For instance, it could have a pan-like configuration with chimneys for the passage of the vapor in place of the cruciform configuration. As could be appreciated, this would be more complex, if not more expensive to fabricate than the illustrated pre-distributor 28.

As can also be appreciated by those skilled in the art, several vapor-liquid contact devices such as illustrated herein can be located in a distillation column depending upon the requirements of the distillation being conducted. For instance, vapor-liquid contact devices can be located between intermediate feed and draws to and from a distillation column. Also, two or more of such vapor-liquid contact devices could be employed in series between intermediate feed and draws. Furthermore, if a wider column were used, several arrays of elongated strips that surrounded elongated strips 34 and 36 could be present along with concentric annular top and bottom support elements with the top support elements being staggered in the manner of top support elements 48 and 50 to allow for the escape of the vapor phase. Although elongated strips 34 and 36 and any successive outlying elongated strips are oriented in a radial direction as viewed along the width of each of the strips, it is possible to orient the strips in a direction parallel to a tangent of the circular arc of the top and bottom support elements. However, this would not be preferred due to complexity in construction and the fact that fewer strips would be present to provide surface area for the descending film. It is also to be noted that although the top support elements 48 and 50 and their associated liquid distributors 30 and 32 are made of separate connected elements, it is possible that such top section of the structure supporting the elongated strips 34 and 36 be fabricated from a single element, for instance, in an appropriate case, from a single molded part. In regard to this latter point, the illustrated vapor-liquid contact device 2 can be made of aluminum so as to be compatible with oxygen-rich mixtures from a safety standpoint. A yet further point is that although a pre-distributor 28 forms part of the vapor-liquid contact device, it could be a separate element. It is to be noted that although the outer column shell 3 is of cylindrical configuration, it is possible that the present invention could be employed in any type of column cross-section, for instance rectangular. In such case, the top and bottom support elements, such as top support elements 48 and 50 and bottom support elements 52 and 54 could be rectangular-like rings.

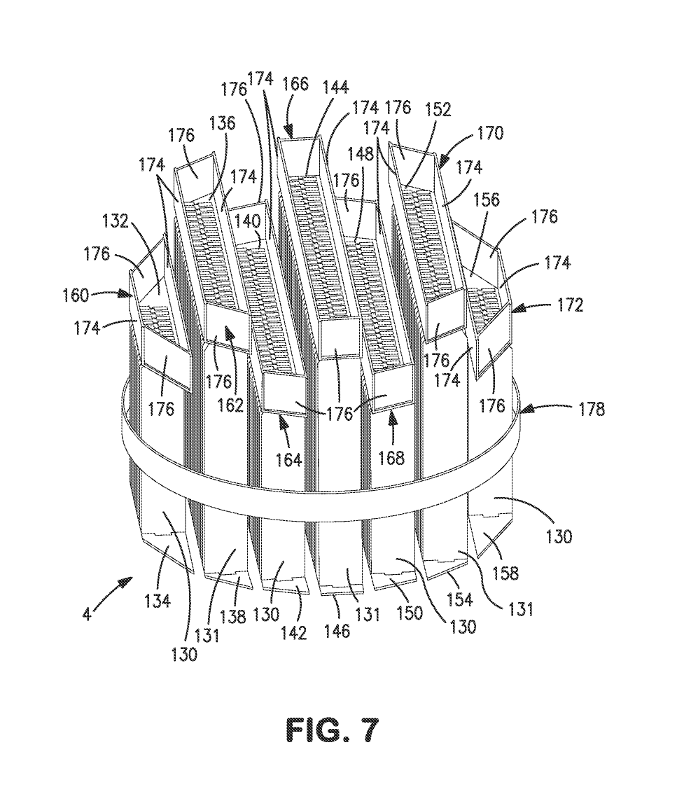

With reference to FIG. 7, a vapor-liquid contact device 4 is illustrated that constitutes an alternative embodiment in accordance with the present invention. Gas-liquid contact device 4 consists of individual arrays of elongated strips 130 and 131 attached to separate pairs of top and bottom support elements 132, 134; 136, 138; 140, 142; 144, 146; 148, 150; 152, 154; and 156, 158. Elongated strips 130 are shorter than elongated strips 131 to allow the vapor phase to upwardly escape from the resulting structure. Although not illustrated, the bottom support elements 135, 138, 142, 146, 150, 154 and 158 would have slot-like openings to allow vapor to ascend through the structure and liquid to descend from the structure. The attachment of the elongated strips 130 and 130 to such support elements is accomplished by tabs in the same manner as described above for elongated strips 34 and 36. The top support elements 132, 136, 140, 144, 148, 152 and 156 form the bottom walls of the liquid distributors 160, 162, 164, 166, 168, 170 and 172. Such liquid distributors also have side and end walls, generally indicated by reference numbers 174 and 176. It is to be noted that the side and end walls 174 and 176 outline trapezoids so as to conform to the column shell. Also, although not illustrated, the column shell itself would form part of the structure supporting the elongated strips 34 and 36 in that the liquid distributors 160, 162, 164, 166, 168, 170 and 172 would be clipped to the column shell. Liquid would be prevented from by-passing the foregoing assemblage of elements by means of a conventional wiper band 178.

Gas-liquid contact device 4 would be a more complex structure to fabricate as compared with vapor-liquid contact device 2. It certainly would be a more complex structure to install in a column given the number of clips that would be required to affix the components to the column shell. In this regard, with additional reference to FIG. 1, another advantage of the vapor-liquid contact device 2 is that it can be simply installed by means of attaching the axial elongated member 56 to an I-beam 57.

While the present invention as been described with reference to preferred embodiments, as will occur to those skilled in the art, numerous changes, omissions and additions can be made thereto without departing from the spirit and scope of the invention as set forth in the appended claims.

We claim:

1. A vapor-liquid contact device comprising:
a plurality of arrays of elongated strips to support a falling film of a liquid, descending on the elongated strips on opposite surfaces of each of the elongated strips;
a support structure having a top section and a bottom section, spaced apart from one another, connected to the arrays of the elongated strips, at opposite ends of the elongated strips and supporting the plurality of arrays of elongated strips in a parallel relationship and with the opposite surfaces of the elongated strips spaced apart from one another, as viewed between adjacent strips, so as to prevent liquid in the falling film from migrating from one of the adjacent strips to the other of the adjacent strips by means of surface tension of the liquid;
the top section having apertures in registry with the elongated strips so that liquid distributed to the top section seeps out of the apertures onto the opposite surface of each of the strips to initiate the formation of the falling film of the liquid and the support structure having openings, at the top and bottom sections, so that a vapor is able to pass through the support structure to contact the falling film to effect contact between the liquid and the vapor; and
liquid distributors associated with the top section to distribute the liquid to the apertures.

2. The vapor-liquid contact device of claim 1, wherein:
the top section and the bottom section respectively comprise pairs of top and bottom support elements, each of annular configuration and of successively decreasing radius such that as between adjacent pairs of top and bottom support elements an inner pair is located within an outer pair of the pairs of top and bottom support elements;
the support structure has an axial elongated member passing through geometric centers of the pairs of top and bottom support elements;
the pairs of top and bottom support elements are connected to the axial elongated member to support the pairs of top and bottom support elements; and
the arrays of the elongated strips are connected to the pairs of top and bottom support elements such that the elongated strips of each of the arrays have a radial orientation in a transverse direction of the elongated strips.

3. The vapor-liquid contact device of claim 2, wherein each of the pairs of top and bottom support elements are connected to a single array of the plurality of arrays of elongated strips.

4. The vapor-liquid contact device of claim 2, wherein the top support elements of the pairs of the top and bottom support elements are vertically staggered so that as between the adjacent pairs of the top and bottom support elements, a top support element of an inner pair of the top and bottom support elements is located above the top support element of the outer pair of the pairs of top and bottom support elements and one of the openings in the support structure at the top support elements for passage of the vapor is formed by a spacing resulting from the vertical stagger between the top support elements of the adjacent pairs of the top and bottom support elements.

5. The vapor-liquid contact device of claim 4, wherein:
the liquid distributors comprise reservoirs to retain the liquid phase, the reservoirs having inner and outer cylindrical sidewalls connected to annular bottom walls; and
the annular bottom walls are connected to the top support elements and have corresponding apertures in registry with the apertures of the top support elements to allow the liquid to flow from the reservoirs to the apertures of the top support elements.

6. The vapor-liquid contact device of claim 5, further comprising:
a pre-distributor located above the liquid distributors; and
the pre-distributor having a bottom wall of cruciform configuration and interconnected rectangular side and end walls connected to the bottom wall to retain the liquid, the bottom wall having further openings overlying the liquid distributors to distribute the liquid to the reservoirs of the liquid distributors.

7. The vapor-liquid contact device of claim 6, wherein:
an innermost of the liquid distributors is connected to the axial elongated member and successive outer liquid distributors are connected to inner distributors by tabs; and
an innermost bottom support element of the pairs of top and bottom support elements is connected to the axial elongated member and successive bottom support elements of the pairs of top and bottom support elements are connected to one another;
whereby, connections of the liquid distributor by the tabs and the bottom support elements to one another connect the pairs of top and bottom support elements to the axial elongated member.

8. The vapor-liquid contact device of claim 7, wherein the axial elongated member has a keyway to align the top and bottom support elements and thereby prevent the elongated strips from twisting.

9. The vapor-liquid contact device of claim 8, wherein:
the elongated strips are flexible and have a pair of tabs located at opposite ends of each of the elongated strips; and
the top and bottom support elements have slots within which the opposite ends of the elongated strips extend with the pair of tabs folded in opposite directions to hold the elongated strips in place and in tension.

10. The vapor-liquid contact device of claim 9, wherein:
a fixed tension plate is connected to the axial elongated member; and
the bottom support elements are connected to the fixed tension plate by threaded connectors that allow the tension of the elongated strips to be adjusted.

11. The vapor-liquid contact device of claim 10, wherein a plurality of wiper bands are connected to the support structure to prevent the liquid from by-passing the vapor-liquid contact device by flowing along a sidewall of a distillation column housing the vapor-liquid contact device.

12. The vapor-liquid contact device of claim 11, wherein each of the pairs of top and bottom support elements are connected to a single array of the plurality of arrays of elongated strips.

13. A distillation column comprising:
an outer shell having inlets and outlets to allow a vapor and a liquid to be introduced into the outer shell and thereby initiate formation of a liquid phase and a vapor phase of a mixture to be distilled; and
a vapor-liquid contact device located within the outer shell and comprising:
(i) a plurality of arrays of elongated strips to support a falling film of the liquid phase, the falling film descending on the elongated strips on opposite surfaces of each of the elongated strips;
(ii) a structure having a top section and a bottom section, spaced apart from one another, connected to the arrays of the elongated strips, at opposite ends of the elongated strips, to at least in part form a support structure supporting the plurality of arrays of elongated strips in a parallel relationship and with the opposite surfaces of the elongated strips spaced apart from one another, as viewed between adjacent strips, so as to prevent liquid in the falling film from migrating from one of the adjacent strips to the other of the adjacent strips by means of surface tension of the liquid;
(iii) the top section having apertures in registry with the elongated strips so that liquid distributed to the top section seeps out of the apertures onto the opposite surface of each of the strips to initiate the formation of the falling film of the liquid and the support structure having openings, at the top and bottom support elements, so that the ascending vapor phase is able to pass through the structure and to contact the falling film to effect mass transfer between the liquid phase and the ascending vapor phase and thereby increase concentrations of heavier components of the mixture within the liquid phase at it descends and lighter components of the mixture within the ascending vapor phase as it ascends;
(iv) liquid distributors associated with the top section to distribute the liquid to the apertures; and
(v) a plurality of wiper bands connected to the support structure to prevent the liquid from by-passing the vapor-liquid contact device by flowing along an inner surface of the outer shell of the distillation column.

14. The distillation column of claim 13, wherein:
the outer shell is of cylindrical configuration;
the top section and the bottom section respectively comprise pairs of top and bottom support elements, each of annular configuration and of successively decreasing radius such that as between adjacent pairs of top and bottom support elements an inner pair is located within an outer pair of the pairs of top and bottom support elements;
the support structure has an axial elongated member passing through geometric centers of the top and bottom support elements;
the pairs of top and bottom support elements are connected to the axial elongated member to support the pairs of top and bottom support elements; and
the arrays of the elongated strips are connected to the pairs of top and bottom support elements such that the elongated strips of each of the arrays have a radial orientation in a transverse direction of the elongated strips.

15. The distillation column of claim 14, wherein the top support elements of the pairs of the top and bottom support elements are vertically staggered so that as between the adjacent pairs of the top and bottom support elements, a top support element of an inner pair of the top and bottom support elements is located above the top support element of the outer pair of the pairs of top and bottom support elements and one of the openings in the support structure at the top support elements for passage of the vapor is formed by a spacing resulting from the vertical stagger between the top support elements of the adjacent pairs of the top and bottom support elements.

16. The distillation column of claim 15, wherein:
the liquid distributors comprise reservoirs to retain the liquid phase, the reservoirs having inner and outer cylindrical sidewalls connected to annular bottom walls; and
the annular bottom walls connected to the top support elements and having corresponding apertures in registry with the apertures of the top support elements to allow the liquid phase to flow from the reservoirs to the apertures of the top support elements.

17. The distillation column of claim 16, further comprising:
a pre-distributor located above the liquid distributors; and
the pre-distributor having a bottom wall of cruciform configuration and interconnected rectangular side and end walls connected to the bottom wall of cruciform configuration to retain the liquid, the bottom wall having further openings overlying the liquid distributors to distribute the liquid to the reservoirs of the liquid distributors.

18. The distillation column of claim 17, wherein:
an innermost of the liquid distributor is connected to the axial elongated member and successive outer liquid distributors are connected to inner distributors by tabs; and
an innermost bottom support element of the pairs of top and bottom support elements is connected to the axial elongated member and successive bottom support elements of the pairs of top and bottom support elements are connected to one another;
whereby, connections of the liquid distributor by the tabs and the bottom support elements to one another connect the pairs of top and bottom support elements to the axial elongated member.

19. The distillation column of claim 18, wherein the axial elongated member has a keyway to align the top and bottom support elements and thereby prevent the elongated from twisting.

20. The distillation column of claim 19, wherein:
the elongated strips are flexible and have a pair of tabs located at opposite ends of each of the elongated strips; and
the top and bottom support elements have slots within which the opposite ends of the elongated strips extend with the pair of tabs folded in opposite directions to hold the elongated strips in place and in tension.

21. The distillation column of claim 20, wherein:
a fixed tension plate is connected to the axial elongated member; and
the bottom support elements are connected to the fixed tension plate by threaded connectors that allow the tension of the elongated strips to be adjusted.

22. The distillation column of claim 21, wherein each of the pairs of top and bottom support elements are connected to a single array of the plurality of arrays of elongated strips.

23. A distillation method for distilling a mixture comprising:
introducing a vapor and a liquid into an outer shell of a distillation column and thereby initiating formation of a liquid phase and an ascending vapor phase of the mixture to be distilled;
contacting a falling film of the liquid phase, descending on opposite surfaces of elongated strips of a plurality arrays of the elongated strips, with the ascending vapor phase to effect mass transfer between the descending liquid phase the ascending vapor phase to thereby distill the mixture by increasing concentrations of lighter components of the mixture in the ascending vapor phase as it ascends and the heavier components of the mixture in the descending falling film as it descends;
supporting the plurality of arrays of elongated strips within a support structure in a parallel relationship and with the opposite surfaces of the elongated strips spaced apart from one another, as viewed between adjacent strips, to prevent liquid in the falling film from migrating from one of the adjacent strips to the other of the adjacent strips by means of liquid surface tension, the support structure having a top section and a bottom section connected to the arrays of the elongated strips, at opposite ends of the elongated strips;
forming the falling film by distributing the liquid phase from liquid distributors associated with the top section to apertures defined in the top section and in registry with the elongated strips so that liquid phase seeps out of apertures onto the opposite surfaces of each of the strips to initiate the formation of the falling film of the liquid phase;
introducing the ascending vapor phase into the structure at the bottom section so that it ascends within the structure to contact the falling film and escapes from the arrays of the elongated strips after having contacted the falling film from openings in the structure at the top section; and
preventing the liquid phase from by-passing the support structure and the elongated strips by flowing along an inner surface of the outer shell of the distillation column with a plurality of wiper bands connected to the support structure.

24. The distillation method of claim 23, wherein:
the outer shell is of cylindrical configuration;
the top section and the bottom section comprise pairs of top and bottom support elements are each of annular configuration and of successively decreasing radius such that as between adjacent pairs of top and bottom support elements an inner pair is located within an outer pair of the pairs of top and bottom support elements;
the support structure has an axial elongated member passing through geometric centers of the top and bottom support elements;
the pairs of top and bottom support elements are connected to the axial elongated member to support the pairs of top and bottom support elements;
the arrays of the elongated strips are connected to the pairs of top and bottom support elements such that the elongated strips of each of the arrays have a radial orientation in a transverse direction of the elongated strips; and
the top support elements of the pairs of the top and bottom support elements are vertically staggered so that as between the adjacent pairs of the top and bottom support elements, a top support element of an inner pair of the top and bottom support elements is located above the top support element of the outer pair of the pairs of top and bottom support elements and one of the openings in the support structure at the top support elements for passage of the vapor is formed by a spacing resulting from the vertical stagger between the top support elements of the adjacent pairs of the top and bottom support elements.

25. The distillation method of claim 24, wherein:
the liquid distributors comprise reservoirs to retain the liquid phase, the reservoirs having inner and outer cylindrical sidewalls connected by a annular bottom wall that is in turn connected to the top support elements; and
the liquid phase is distributed from the liquid distributors from corresponding apertures defined in the annular bottom wall and in registry with the apertures of the top support elements to allow the liquid to flow from the reservoirs to the apertures of the top support elements.

26. The distillation method of claim 25, further comprising:
pre-distributing the liquid phase from a pre-distributor located above the liquid distributors; and
distributing the liquid to the reservoirs of the liquid distributors from further openings defined in the bottom wall and overlying the liquid distributors.

27. The distillation method of claim 25, wherein the mixture is air or the mixture is enriched in components of the air.
